(19) United States
(12) Patent Application Publication
(10) Pub. No.: US 2015/0120535 A1
(43) Pub. Date: Apr. 30, 2015

(54) MEDIA DISTRIBUTION SYSTEMS AND METHODS

(71) Applicant: Damon Evans, Phoenix, AZ (US)

(72) Inventor: Damon Evans, Phoenix, AZ (US)

(21) Appl. No.: 14/527,470

(22) Filed: Oct. 29, 2014

Related U.S. Application Data
(60) Provisional application No. 61/898,380, filed on Oct. 31, 2013.
(60) Provisional application No. 61/968,818, filed on Mar. 21, 2014.

(51) Int. Cl. G06Q 20/14; H04L 29/06

(52) U.S. Cl. CPC G06Q 20/14; H04L 65/60
USPC 705/39; 709/219

(57) ABSTRACT

Systems and methods for media distribution enable consumers to obtain access to media content, for example without financial payment, while content creators and owners simultaneously achieve above-market financial payments for the corresponding media content. Exemplary media distribution systems utilize a “listen to own” model whereby a consumer is provided downloadable access to an item of media content after streaming the content a selected number of times.

### CROSS REFERENCE TO RELATED APPLICATIONS

This application is a non-provisional of U.S. Provisional No. 61/898,380 filed on Oct. 31, 2013 and entitled “METHOD AND SYSTEM FOR AUDIO/VIDEO DISTRIBUTION.” This application is also a non-provisional of U.S. Provisional No. 61/968,818 filed on Mar. 21, 2014 and entitled “ALTERNATIVE METHOD AND SYSTEM FOR AUDIO/VIDEO DISTRIBUTION VIA LISTENING TO OWN.” The entire contents of all the foregoing applications are hereby incorporated by reference.

### TECHNICAL FIELD

The present disclosure relates to media distribution, and in particular to streaming and downloading of digital media and to distribution of related physical items.

### BACKGROUND

The rise of streaming media distribution platforms has disrupted traditional media distribution channels. Prior approaches, such as compact discs and DVDs, are in an ongoing and likely irreversible decline. However, newer streaming media approaches, such as Pandora, Spotify, and the like, offer only limited revenue to artists, and limited flexibility for consumers. Accordingly, improved methods and systems for media distribution are desirable.

### SUMMARY

The present disclosure relates to media distribution, and in particular to a method and system for media distribution comprising the streaming and downloading of digital media and the distribution of related physical items to consumers. In an exemplary embodiment, a method for media distribution comprises delivering, via an electronic media distribution system, a streaming media file to a user. The streaming media file is delivered to the user a plurality of times. The method further comprises providing, responsive to the streaming media file being delivered to the user a selected number of times, in the electronic media distribution system, a downloadable file for download by the user. The downloadable file contains content corresponding to the streaming media file.

In another exemplary embodiment, a system for electronic media distribution comprises a streaming component configured to provide streaming delivery of electronic media to a user, a payment component configured to receive payments from users for purchases of media, and a download component configured to provide electronic media in downloadable format to the user. Responsive to a streaming media file being delivered to the user by the streaming component a selected number of times, the download component provides access to a downloadable file for download by the user. The downloadable file contains content corresponding to the streaming media file.

The contents of this summary section are intended as a simplified introduction to the disclosure, and are not intended to limit the scope of the appended claims.

### BRIEF DESCRIPTION OF THE DRAWINGS

With reference to the following description, appended claims, and accompanying drawings:

FIG. 1 illustrates a block diagram of a media distribution system in accordance with various exemplary embodiments;

FIGS. 2A through 2F illustrate aspects of exemplary media distribution systems and methods in accordance with various exemplary embodiments;

FIG. 3 illustrates payment flow in an exemplary media distribution system in accordance with various exemplary embodiments;

FIG. 4 illustrates a method for user streaming and downloading media in accordance with various exemplary embodiments;

FIG. 5 illustrates a method for media distribution in accordance with various exemplary embodiments; and

FIG. 6 illustrates a method for media distribution in accordance with various exemplary embodiments.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended claims.

For the sake of brevity, conventional techniques for media distribution, media streaming, media transcoding, media storage, user preference management, media recommendation, and/or the like, may not be described in detail herein. Furthermore, the connecting lines shown in various figures contained herein are intended to represent exemplary functional relationships, method steps, and/or communicative couplings between various elements. It should be noted that many alternative or additional functional relationships, steps, or connections may be present in a practical media distribution system and/or associated methods.

Various shortcomings of prior media distribution approaches can be addressed by utilizing media distribution systems and methods configured in accordance with principles of the present disclosure. For example, certain prior distribution systems have offered limited payouts to artists. Additionally, many prior distribution systems offered media at prices higher than a typical consumer is willing to pay.

In contrast, an exemplary media distribution system 100 for media distribution enables significantly increased payouts to artists, while providing streaming and/or downloadable media to consumers without monetary charge. Via use of media distribution system 100 and associated methods, a long-term sustainable media ecosystem is facilitated, whereby consumers are provided “free play”, and artists are accorded “fair pay”.

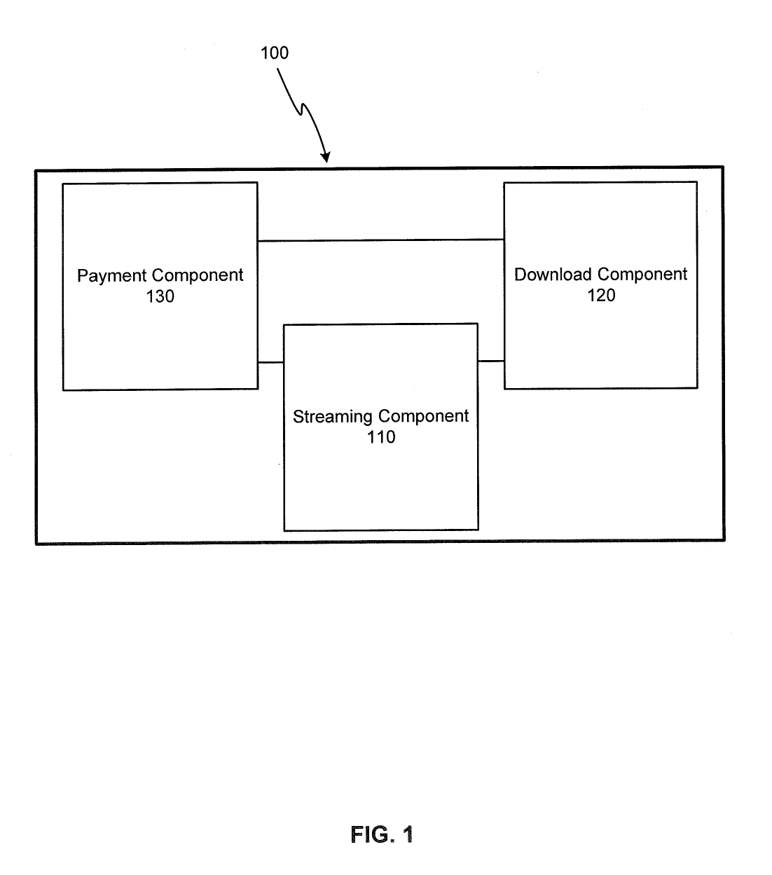

With reference now to FIG. 1, an exemplary media distribution system 100 may be any system or combination of systems configured to enable distribution of media. In an exemplary embodiment, media distribution system 100 comprises a streaming component 110, a download component 120, and a payment component 130. Streaming component 110 is configured to enable streaming of media to consumers. Download component 120 is configured to enable media downloads by consumers. Payment component 130 is configured to receive payments into media distribution system 100 (for example, from advertisers, content owners, and/or the like) and to make payments from media distribution system 100 (for example, to artists, publishers, performance rights organizations, and/or the like). It will be appreciated that streaming component 110, download component 120, and payment component 130 may be implemented via any suitable software, hardware, and/or other electronic components.

In various exemplary embodiments, media distribution system 100 may comprise a website hosted on a server or servers as is known in the art. Additionally, media distribution system 100 may comprise application software suitable for use on a mobile device, for example a tablet, smartphone, and/or the like. A user may create an account in media distribution system 100 in order to access streaming and/or downloadable media content, purchase merchandise, and/or the like; similarly, artists and other rights holders may create an account in media distribution system 100 in order to upload content, receive payments, track media distribution statistics, and/or the like.

As described in more detail herein, methods and systems for audio, video, and/or merchandise distribution are disclosed. Exemplary systems may comprise a self-publishing platform that does not require a surrender of ownership, copyright or shares of royalties made from traditional product sales, while still exceeding the legal statutory payout rates for streaming audio royalties.

As used herein, “media”, “media content”, “content”, and/or the like may be: (i) audio content such as music, spoken words, event recordings, audiobooks, and/or the like; (ii) audio-visual content such as music videos, movies, television shows, amateur video, and/or the like; and/or (iii) any other content suitable for electronic distribution. Accordingly, it will be appreciated that terms such as “listen”, “view”, “watch”, “review”, and/or the like may be utilized somewhat interchangeably herein to refer to consumption or use of media content, for example by a consumer.

In various exemplary embodiments, media distribution system 100 provides free consumer access to streaming media channels free of charge, while paying artists a fair rate per listen. In various embodiments, media distribution system 100 utilizes participation from (i) music artists who create media content for streaming, (ii) affiliate disc jockeys (DJ's) who play and promote media content channels, and (iii) fans who report, share and attract new media content creators, for example via social interactions. In some embodiments, other entities may participate, for example advertisers, producers, record companies, and/or the like.

In various exemplary embodiments, media distribution system 100 can provide an end-game strategy to address ongoing and disruptive changes in media distribution. For musicians, it can be a blueprint for rebuilding a new and fair artist-controlled music industry. Exemplary methods and systems can make it possible for both recording artists and film makers to navigate a fragmented marketplace, for example by eliminating the need for labels, consultants and most all other “middle man” type functions. From mail order sales to mobile streaming, the exemplary methods and systems are the only full service solution that pays artists a high percent (for example, up to 100%) of all the net royalties earned monthly from digital and physical product sales.

In various exemplary embodiments, depending on the level of professionalism, sales history, quality of artist album artwork and band photos, and the like, content owners may be given the option to either (i) pre-pay a one-time setup fee per project in order to access media distribution system 100, or (ii) backend the setup fee so there is no up-front out-of-pocket expense to utilize media distribution system 100. A corresponding fee is paid back into media distribution system 100 from the first royalties generated from sales.

In various exemplary embodiments, media distribution system 100 may be configured with multiple service options. In one exemplary embodiment, media distribution system 100 is configured with two base service options for an artist:

Option A.

Pay $0 setup fee, earn $0 for promotional audio streams, and keep 85% of all product sales royalties.

Option B.

Pay a one-time setup fee (either up front or backend from first sales), get paid directly $0.21 per audio stream for certain selected tracks per project (for example, up to 3 tracks)+$0.01 for all additional streams from the same project, and keep 85% of all product sales in exchange for unlimited album promotion in media distribution system 100.

It will be appreciated that additional service options may be included in media distribution system 100, for example in order to address specific types of media. In media distribution system 100, a higher payment tier (for example, $0.21 per stream) may be referred to as a premium payment tier, and a lower payment tier (for example, $0.01 per stream) may be referred to as a standard payment tier.

In various exemplary embodiments, media distribution system 100 can offer the highest per unit payout in the music industry. For example, media distribution system 100 and related methods provide the only streaming platform that pays artists a premium payment tier, for example $0.21 per stream for up to 3 singles per album. This amount is a higher payout stream than typical and newer media distribution entities would pay collectively for the same single stream. In media distribution system 100, tracks set up on the $0.21 tier may be interchanged and/or rotated with other singles from the same album at any time, for example as desired by an artist, making it possible to maximize marketing efforts. Even the tracks that are not selected for the elevated $0.21 payoff tier still generate a full penny per stream.

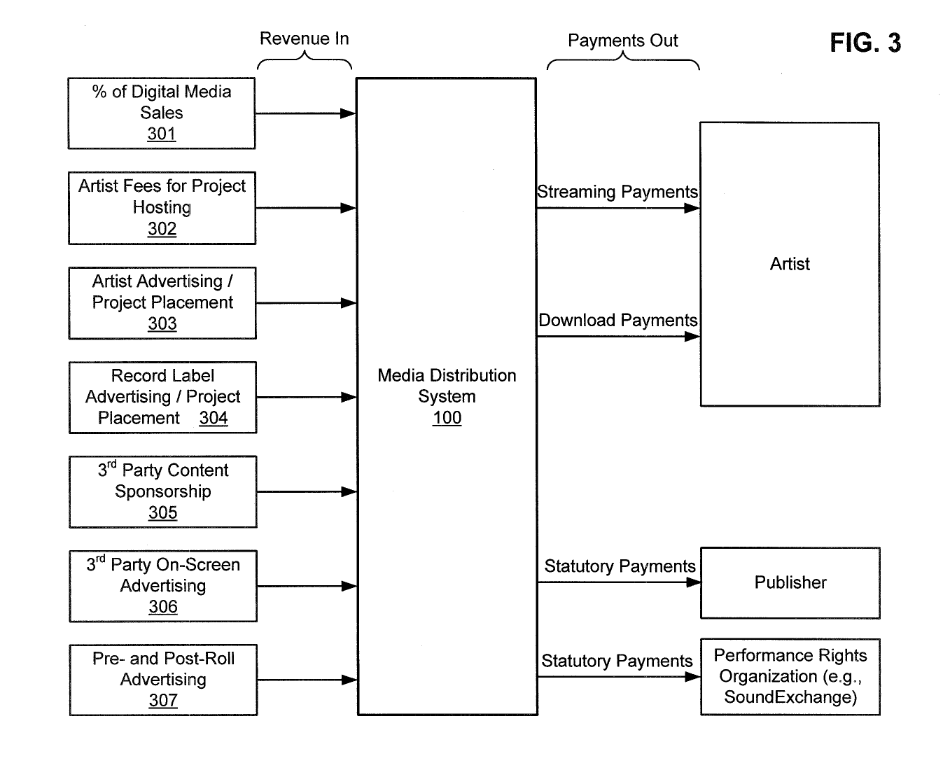

With reference now to FIG. 3, in various exemplary embodiments, media distribution system 100 is configured to obtain incoming revenue from various channels. Thereafter, media distribution system 100 distributes certain payouts to artists, publishers, performance rights organizations, and/or the like. The pool of money used to generate above market rate payouts for media streams is compiled from multiple sources, such as:

Element 301—a % of any sale an opted-in artist makes from selling and promoting content in connection with media distribution system 100;

Element 302—a % of sign-up fees a content owner pays to host their content in media distribution system 100;

Element 303—a % of the revenue content owners pay to advertise in media distribution system 100 via in-app project placements;

Element 304—a % of the revenue labels and catalog owners pay to advertise in media distribution system 100 via in-app placements;

Element 305—a % of third party sponsorship of content in media distribution system 100;

Element 306—a % of third party advertising revenue in media distribution system 100; and

Element 307—a % of pre-roll and post-roll advertising revenue, for example for video content accessible via media distribution system 100.

It will be appreciated that additional revenue sources may be utilized by media distribution system 100, for example donations from users/fans, licensing/partnership revenues, and/or the like.

In various exemplary embodiments, in media distribution system 100, artists, film makers, and other content creators may promote and advertise their projects throughout media distribution system 100's desktop, mobile and/or tablet versions, for example using images created from their album artwork or band photos. This promotion and/or advertising may be paid in exchange for a percentage of their monthly sales, for example 15%. In various exemplary embodiments, media distribution system 100 is non-exclusive; stated another way, content creators may utilize media distribution system 100 in addition to and/or in parallel with other distribution channels and/or partners. However, media distribution system 100 provides an attractive storefront option and administrative console to provide a one-stop solution for every level of artist, musician, or other content creator.

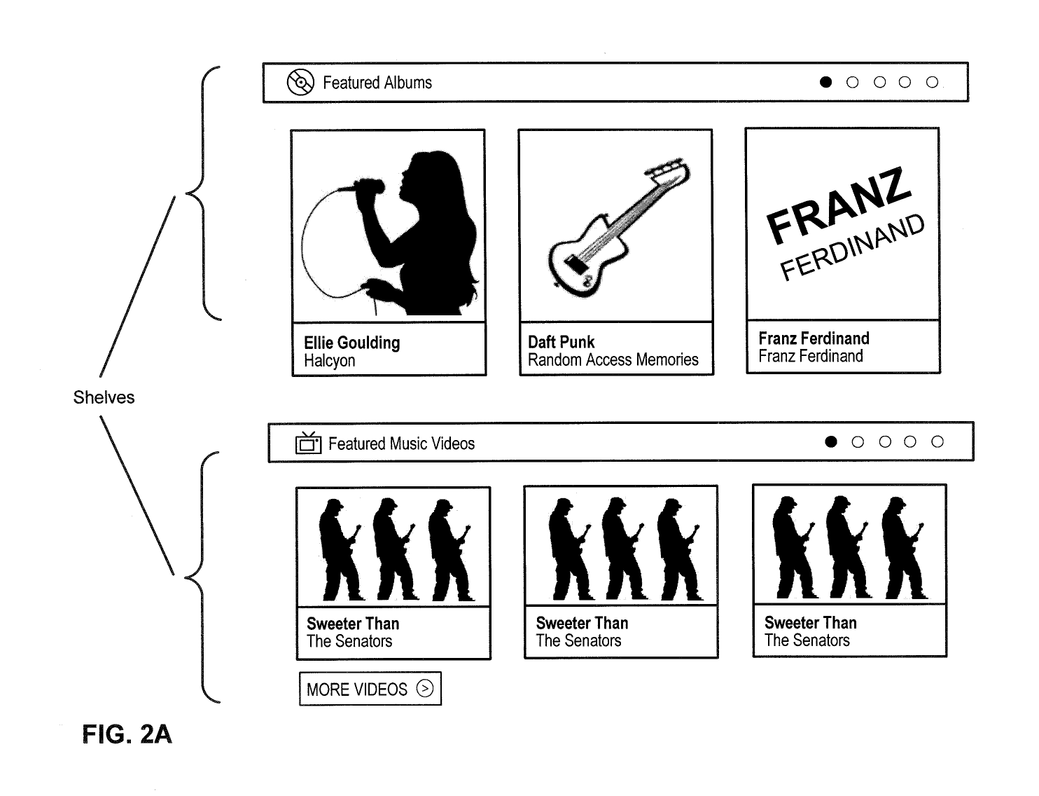

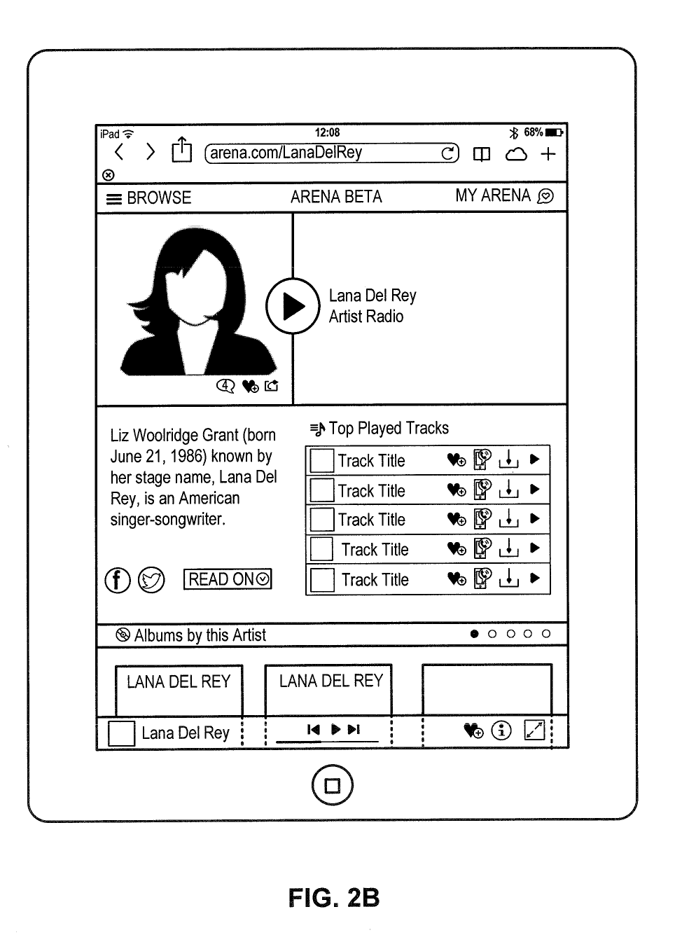

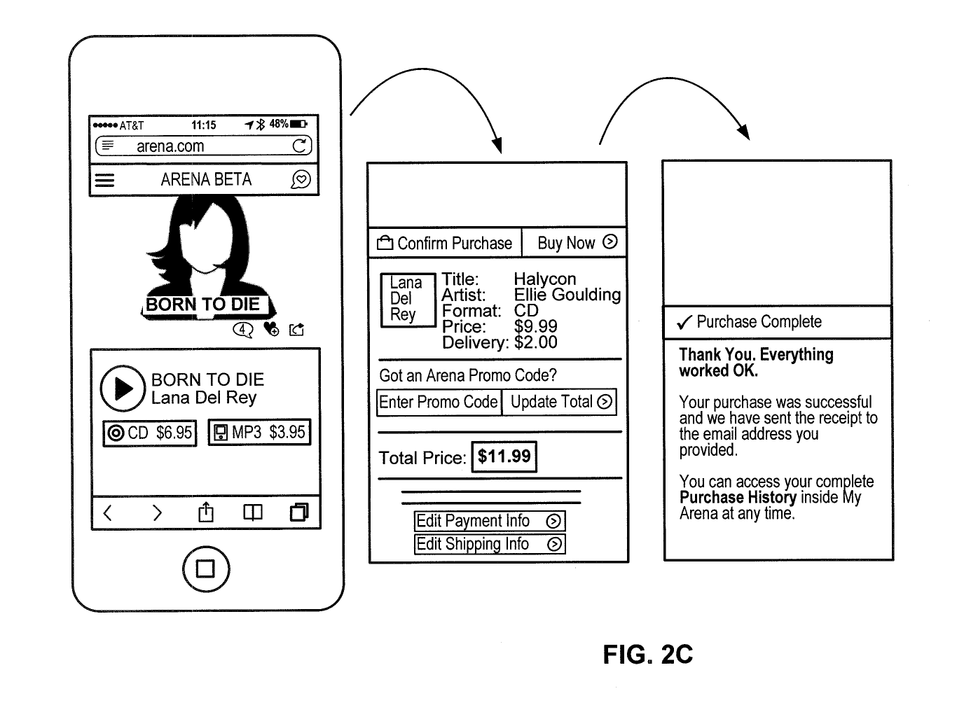

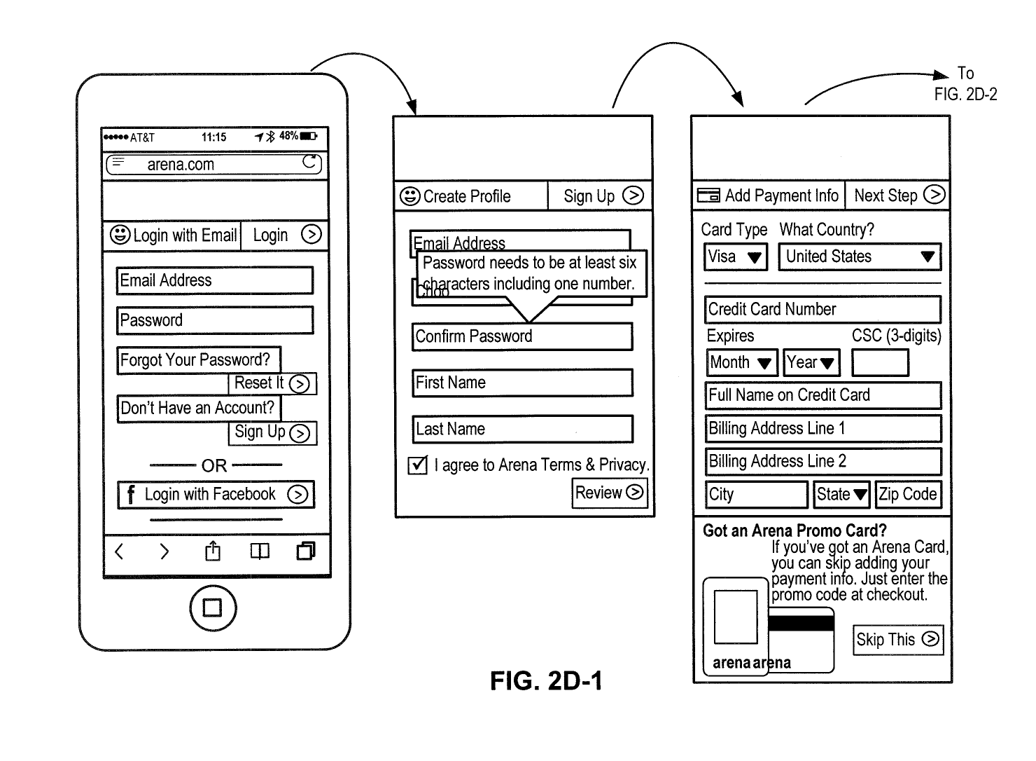

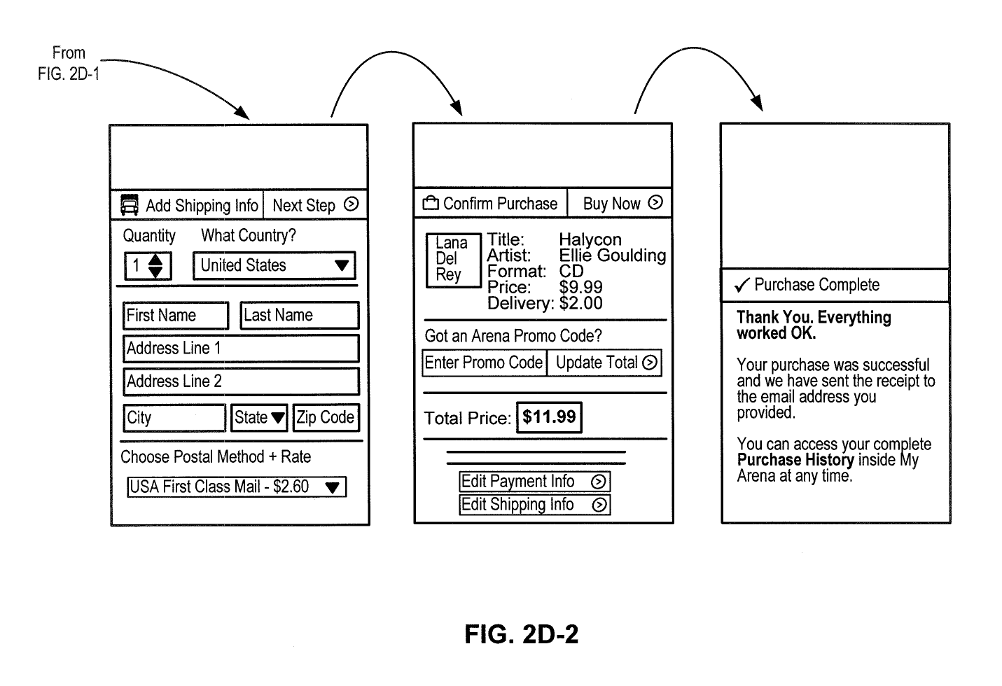

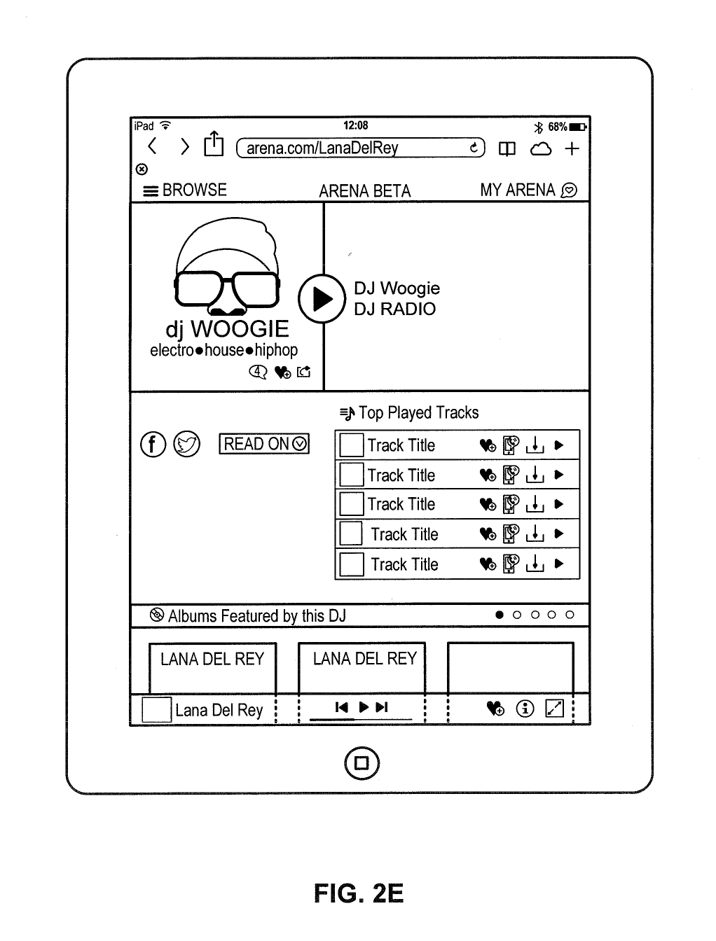

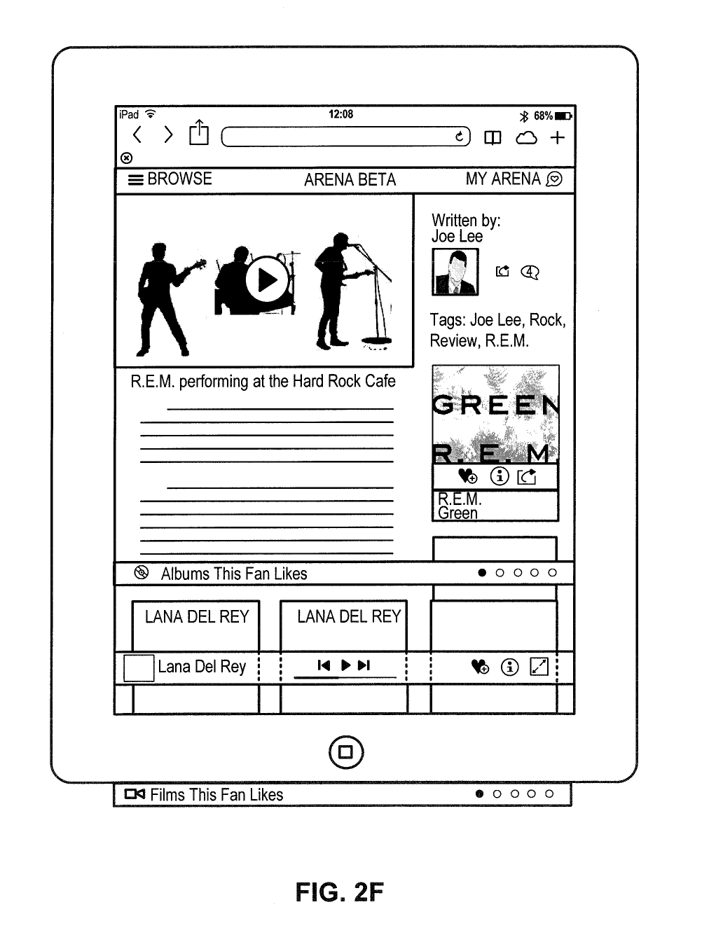

FIG. 2A illustrates a graphic display and summary of in-app advertising components of media distribution system 100 in accordance with various exemplary embodiments. In media distribution system 100, content advertising may be integrated into the user interface design and appears seamless, eliminating a disruptive and harassing browsing experience. Artists can pay to feature their content in relevant locations in media distribution system 100. As used herein, certain locations in media distribution system 100 may be referred to as “shelves”. Examples of advertising shelves in media distribution system 100 include, but are not limited to, shelves such as: A) Featured Albums; B) Featured Artist Radio; C) Featured Movies-on-Demand; D) Featured Music Videos; E) Featured Merchandise; and F) Featured Ringtones. It will be appreciated that the number and type of shelves may be varied, as desired.

Turning now to FIG. 2B, in various exemplary embodiments, media distribution system 100 comprises an online and/or streaming radio system. Consumers can stream music from an artist, mix of artists, similar sounding artists, and so forth. Media distribution system 100 allows artists to promote and sell their content within a single integrated platform. In various exemplary embodiments, media distribution system 100 offers functionality including: (i) Streaming—streaming of singles, streaming of albums, streaming of complete artist discographies, streaming of music videos, and other streaming configurations (user playlists, etc.); (ii) Media Purchases—purchase singles, albums, movies, and the like, either as a downloadable file or on physical media for delivery; (iii) Merchandise Purchases; and (iv) Mobile Content Purchases—purchase ringtones, apps, wallpapers, and/or the like.

In various exemplary embodiments, media distribution system 100 is configured to be low cost or no cost to use for a consumer. Additionally, media distribution system 100 may be configured to learn and/or adapt to user preferences, for example via algorithm-based assessments of purchases, streaming history, user demographics, and/or the like. In media distribution system 100, exclusive artist interviews, editorial features, regional music news, suggested playlists, new releases, and/or the like may be recommended and categorized by style and genre. Users can stream thousands of full albums, artist specific playlists or generate and share an unlimited number of user-created playlists.

Moreover, while prior platforms rely only on computer-generated algorithms to create recommendations and suggestions, media distribution system 100 is the only streaming service in existence that employs new and/or established DJs to create exclusive playlists and introduce new and emerging artists. Such DJs may also tour, and users of media distribution system 100 can stream their live broadcasts and exclusive show footage audio commercial free.

In media distribution system 100, purchasing, sign-up and checkout can also be made simpler for artists and consumers. For example, media distribution system 100 may be configured with integrated purchasing capabilities. Artists can sell their content via an integrated storefront that works across all web connected devices within one single integrated platform.

With reference now to FIG. 2C, in certain exemplary embodiments, in media distribution system 100 a user may be enabled to utilize a 2-click checkout. User information and payment information are obtained at user registration or thereafter. Once a user is signed-in to media distribution system 100, the user simply clicks the purchase button associated with a media item. The user then reviews the purchase details and clicks BUY NOW . . . that's it . . . 2 clicks to purchase any product format.

Turning now to FIGS. 2D-1 and 2D-2, in various exemplary embodiments, media distribution system 100 may be configured to facilitate quick sign-up and checkout. In this example, Step 1: a user reviewing media details clicks a purchase button and is prompted to securely sign in. Step 2: the user creates a free profile in media distribution system 100. Step 3: The user adds payment information, which may be securely stored in their profile for future purchases. Step 4: the user adds shipping information (if necessary, for purchase of physical media or merchandise), which may be stored on their profile for future purchases. In Step 5: the user confirms purchase details, and the transaction is complete.

In accordance with a various exemplary embodiments, with reference to FIG. 2E, media distribution system 100 encourages fan and professional DJ participation by rewarding them with a percentage of the total advertising revenue generated during active listens and fan “favoriting” of their playlists. In media distribution system 100, an exemplary DJ Affiliate Program is available to anyone who builds a playlist of approximately 100 tracks or more and is able to attract, for example, 500 channel subscribers. Starting with subscriber number 501, the DJ earns 10% of the advertising revenue generated during all playlist listens. The playlist size and channel subscriber thresholds may be varied, as desired, in order to achieve a desired level of payouts, participation, and so forth.

In media distribution system 100, affiliates and professional DJ's can create unique channels and playlists from the platform's catalog. Affiliates and DJ's can form an important part of media distribution system 100's media ecosystem, encouraging fans to listen and stream and thus generate traffic and in-app advertising impressions. The DJ receives a percentage of the advertising revenue generated when their playlist or channel is playing.

With reference now to FIG. 2F, in various exemplary embodiments, media distribution system 100 is configured to reward fan support. Fans can create articles, editorials and reviews of the music they like and submit to media distribution system 100. Fans also can create shelves of content they like in the catalog of media distribution system 100. These shelves are displayed in media distribution system 100, for example below the submitted articles, and drive traffic and in-app advertising impressions when their fan report is viewed by users. The fans get compensation, for example a flat fee or a percentage of the advertising revenue associated with viewing of their fan report by other users.

In media distribution system 100, in various exemplary embodiments, with respect to artists, project pages support direct to consumer sales for ringtones, downloads, CDs, DVDs, movie rentals, merchandise, and the like. The project pages combine real-time media distribution system 100 sales reports with third party reports, for example reports received from many of the world's most relevant digital storefronts and services. In media distribution system 100, artists can easily manage all aspects of their new releases and back catalog titles, including customizable streaming channels for full albums, complete discographies, genre specific mix-in playlists, and/or the like.

In media distribution system 100, in various exemplary embodiments, music fans can discover new music and directly purchase downloads, ringtones, CD's, merchandise and the like. Media distribution system 100 offers exclusive bundled options that combine digital and physical formats of the same title into one single price point, for example purchase downloads, ringtones and CD version of any participating album release for a competitive price, for example under $10. Moreover, for every 10 full albums purchased, customers may receive an album credit which can be redeemed for 1 free full album download.

In media distribution system 100, individuals and content owners are provided a self-publishing administrative console, free of charge, where project assets and owner information can be uploaded and stored. After building project profiles for a single track, EP, full length album or video file, users can select from multiple options that vary in degree of service. Users are given the opportunity to receive payments directly, or through their publisher under a non-exclusive service agreement. Users maintain 100% ownership and control of copyright and publishing. Payment of any related activation fees is deferred until the artist is ready to begin selling their work.

In various exemplary embodiments, media distribution system 100 makes it possible for content owners to sell direct to a global audience and provides support and administration for physical CD/DVD product sales, digital MP3 downloads, mobile ringtones, merchandise, audio and video streaming, and the like. Additionally, media distribution system 100 compensates artists with the highest per unit payout for each transaction currently available in today's music industry. Table 1 illustrates payout approaches in an exemplary embodiment of media distribution system 100.

TABLE 1

| Product | Payout | % of Net | Pay Cycle |
|---|---|---|---|
| Video Rental | $1.98 | 100% or 85% | Daily |
| Audio Streams | $0.21 | N/A | Monthly |
| (premium rate) | | | |
| Audio Streams | $0.01 | $0.27 per every | Monthly |
| (standard Rate) | | 100 plays | |
| Ringtone/ | $1.98 | 100% or 85% | Daily |
| Voicetone | | | |
| Single Song | $0.99 | 100% or 85% | Daily |
| Download MP3 | | | |
| Download | | | |
| Full Album MP3 | $9.99 | 100% or 85% | Daily |
| Download | | | |
| Mail Order | $9.99 | 100% or 85% | Daily |
| (CD/DVD) | | | |

In addition to the highest per unit payout of any existing US based service, media distribution system 100 also provides content owners with real-time sales reporting and makes it possible for content owners to request daily payments, for example if their total sales reach $100 or more in total earnings. There exists no other US based storefront that provides content owners with this extended level of transparency.

While an exemplary storefront can be a component of media distribution system 100, content owners can also elect to have their content delivered to third party storefronts like iTunes, Amazon MP3, Google Play, Spotify, Pandora, and the like. For sales through third party sites, media distribution system 100 passes a high percentage (for example, up to 100%) of the gross payable back to the content owner. For example, if a full album download on iTunes sells for $9.99, iTunes will keep $3 and pay $7 to media distribution system 100, which in turn is passed through to content owners monthly.

In various exemplary embodiments, media distribution system 100 may be considered a form of “digital socialism”. Stated another way, media distribution system 100 allows everyone equal access at an equal cost, but does not cap on individual success. Much like our existing society, citizens pay into the system in order to enjoy continued success through various levels of federal taxation. In order for content owners to maintain their premium level stream payouts in media distribution system 100, users agree to promote and advertise their project page and streaming channels in exchange for a percent (for example, 15%) of their total monthly sales. Project advertisements may be created, for example from album artwork, band photos and label logos. These advertisements cost the content owner a small amount per impression, for example from about $0.005 to about $0.01 per impression. In various exemplary embodiments, media distribution system 100 pools this monthly advertising revenue and applies 100% of it to funding high-level $0.21 streaming payouts.

In various exemplary embodiments, media distribution system 100 is usable to compensate artists fairly whenever their music is streamed. In exemplary embodiments, consumer access to media distribution system 100's music playlists is free. There are no subscription fees or usage fees no matter how many monthly hours media distribution system 100 is used. In media distribution system 100, in certain exemplary embodiments where advertising revenue is generated from its artist clients, the playlists contain no third party audio advertisements. In contrast, mainstream services rely on harassing audio commercials for the base of their revenue. In addition, the artist payments from media distribution system 100 actually scale up the more the platform is used. Unlike such mainstream services, whose stream payouts actually diminish the more those services are used, media distribution system 100 merely utilizes steady site traffic and direct artist relationships in order to remain sustainable. In various exemplary embodiments, media distribution system 100 is configured to offer a premium stream rate of at least $0.21 per play; moreover, media distribution system 100 may be sustainable at a premium stream rate of up to $0.285 per play.

Media distribution system 100 can provide higher artist revenue than prior approaches. By way of example, if a music artist streamed 8M tracks on media distribution system 100 and 20% of them paid out $0.21 (3 tracks at a time payout $0.21, all other tracks are paid at the standard rate of $0.01), his payment from media distribution system 100 would look something like this:

8M×20%=1,600,000×$0.21=$336,000

6.4M×0.0027=$17,280

for a total of $353,280 in stream revenue.

If 10% of consumers that streamed the music artist's songs purchased the corresponding digital album @ $9.99, the music artist would have made:

800,000×$9.99=$7,992,000

and subtracting the 15% share applied to media distribution system 100, the net payment to the music artist would have been:

$7,992,000 in sales revenue

$1,198,800 advertising

for a total of $6,793,200 from album sales, and $353,280 from streams. This exemplary calculation doesn't include ringtone, merchandise, video or single sales.

An example that's more realistic for an independent release offered via media distribution system 100:

If an artist with a 10 track album sold 1,000 digital albums and streamed 25,000 tracks, the totals would look like this:

1,000 digital albums @ $9.99=$9,999

Streamed 25,000 singles, with 7,500 on the $0.21 tier and 17,500 paying $0.0027=$1,622.25.

That's $11,621.25 in total earnings. Less $1,499.85 in commissions retained by media distribution system 100 ($9,999×0.15), we have a total net payment to artist=$10,121.40.

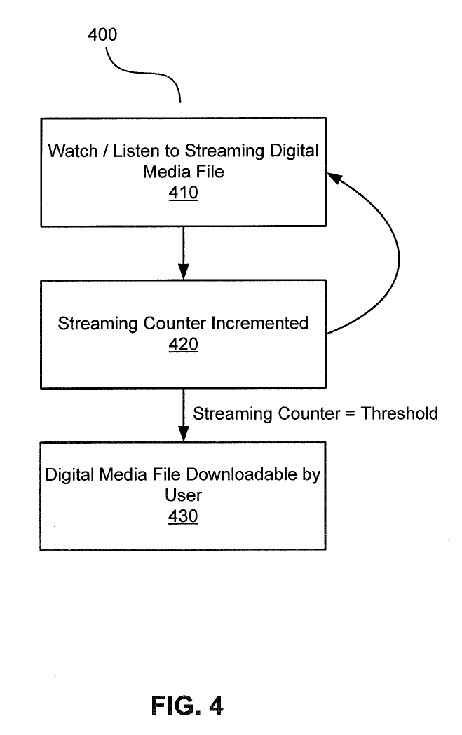

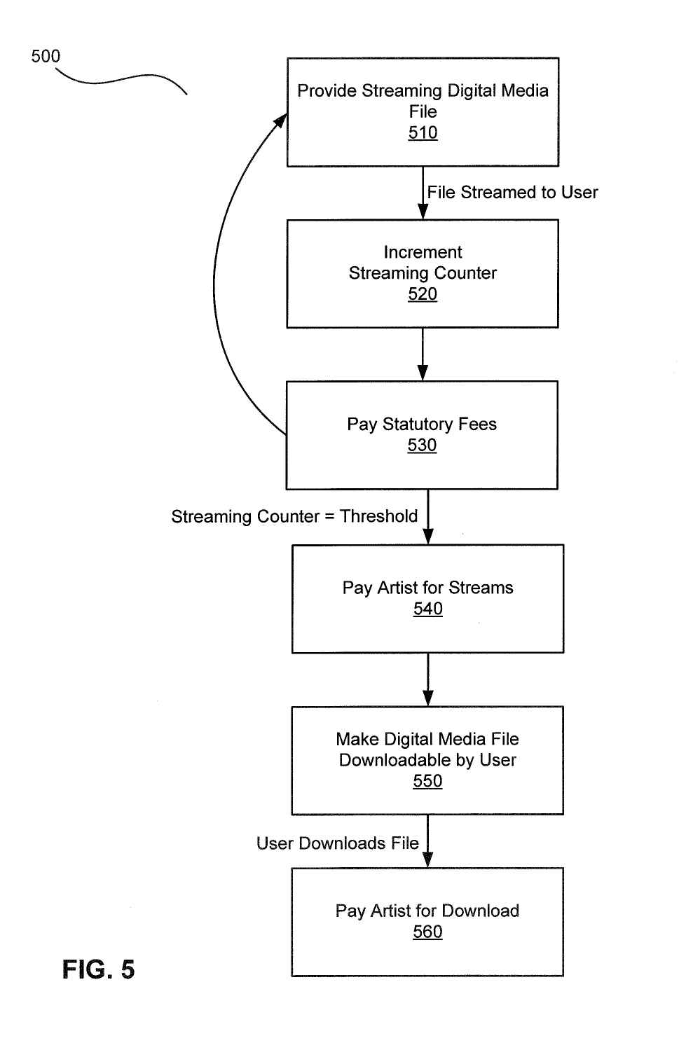

It is understood that the a la carte download of content no longer satisfies the economics of the music industry, as streaming music has compromised consumer interest in buying music to own. However, with reference now to FIGS. 4-5, in accordance with various exemplary embodiments, media distribution system 100 may be configured to combine and/or leverage free streaming access to ultimately provide a user with the ability to own an item of media content (for example, via download) after a certain number of listens or views. The concept may be referred to herein as “Listen to Own”. In various exemplary embodiments, a “Listen to Own” approach may be applied to any streaming service and any per stream pay rate, but can work most optimally with media distribution system 100. Using such concepts, a user can “Listen to Own” the file without making a financial payment for it, while media distribution system 100 pays the artist the equivalent value of a single song purchase on top of the premium stream rate.

For example, if a streaming user listens to one particular song multiple times, a typical streaming service pays a monetary amount per play to artists, publishers and rights holders. Typically, these payments include the legally required payment of no less than $0.0023 to Sound Exchange for the compulsory right and approximately $0.005 to the publisher (BMI, ASCAP, SESAC, etc.).

However, as disclosed herein, media distribution system 100 can pay a variable amount, e.g., $0.21 for premium plays and $0.01 for each standard stream served. If a listener utilizing media distribution system 100 listens to a song five (5) times at $0.21, the money generated equates to $1.05 in premium stream payouts to the artist, copyright owner, and publisher. It will be appreciated that this amount is nearly identical to and/or exceeds the payments associated with conventional pricing for a $0.99 single song download. Thus, at this point, media distribution system 100 pays the artist $0.99 for the single (on top of the $1.05 in streaming revenue earned from the first 5 listens) and media distribution system 100 then provides the listener with access to a downloadable media file, i.e., a file they can “own”.

In various exemplary embodiments, now that the listener “owns” the track and/or corresponding download file, media distribution system 100 considers subsequent streams or plays of that content by the same listener (i.e., the number 6 listen to infinity of the same track), to originate from the listener's library of owned/purchased content. Accordingly, media distribution system 100 may be configured to thereafter allow the listener to play back the track as often as they want, whenever they want, on whatever device they want, all without any obligation of liability on the part of media distribution system 100 to report or pay Sound Exchange, rights holders and the publishers—as such parties have all previously been fully compensated for the track.

In accordance with various exemplary embodiments of media distribution system 100, $0.99 is the approximate industry accepted and established value for a single song purchase. Media distribution system 100 leverages this widely accepted pricing to compensate artists fairly for streams and downloads, for example by allowing the artist to generate about $2.04 per listener per song. Thus, for a 15 track album, a single listener can potentially generate $30.60, or three times more than the industry standard of about $9.99 per album.

In another example of operation of media distribution system 100, for singles priced at $0.01 per stream in media distribution system 100, after a listener streams the song 100 times, media distribution system 100 then pays the artist $0.99 on top of the $1.00 (less statutory fees) from streams, and the listener then owns the content as described earlier.

With reference now to FIG. 4, in an exemplary embodiment, a method 400 for media distribution comprises accessing, by a consumer and via a media distribution system, a streaming media file (step 410). The streaming media file may be an album track, a video, and/or the like, as disclosed herein. When the streaming media has been delivered to the consumer, in the media distribution system a streaming counter associated with the streaming media file and the consumer is incremented (step 420). The media distribution system calculates the resulting payments due to rightsholders and delivers such payments in due course.

In the media distribution system, a payment threshold associated with the streaming media file may be established. For example, the payment threshold may be set to a value roughly equivalent to the price of a digital download purchase. As the consumer repeatedly accesses the streaming media file (i.e., as steps 410 and 420 are repeated), the cumulative payments to rightsholders approach the payment threshold. Once the payment threshold is reached (i.e., once the consumer has streamed the streaming media file a set number of times), media distribution system 100 makes the content of the streaming media file downloadable to the consumer (step 430). The consumer may thereafter import the downloaded file to a management system (for example, iTunes brand software from Apple), copy the downloaded file to a media player, and otherwise fully utilize the downloaded file without restriction.

Turning now to FIG. 5, in various exemplary embodiments, a method 500 for distributing media comprises providing, in a media distribution system (for example, media distribution system 100), content for streaming to a user (step 510). Each time the content is streamed to a user, a streaming counter associated with that content and that user is incremented (step 520). The statutory fees associated with the streaming delivery are paid, for example by the operators of media distribution system 100 (step 530). When the streaming counter associated with the content and a particular user reaches a threshold value (for example, 5 streams, 20 streams, 100 streams, etc.), a payment to the artist is made (step 540) and the content is unlocked in media distribution system 100 so that the user can, if desired, download the content (step 550). If the user downloads the content, a payment associated with the download is made to the artist (step 560).

In addition to “Listen to Own” functionality, media distribution system 100 may be configured with content bundling capability. For example, in various exemplary embodiments, media distribution system 100 offers the ability to purchase merchandise (such as a t-shirt, poster, and/or the like). Access to media content may be included in a bundle with merchandise, for example a “Buy the Merchandise and get the Music free” approach.

When a customer makes a purchase of merchandise having bundled media content, the customer is considered to have purchased the corresponding media content, and thus, after media distribution system 100 makes payment to the artist, publisher, and performance rights organization, no further payments would be incurred by media distribution system 100 when the customer subsequently streams that media content. As an example, if in media distribution system 100 a customer purchases a T-shirt and Album package under a “Buy the T Shirt, Get the Music Free” program for a list price (for example, $24.95, or other suitable price set in media distribution system 100), the customer immediately gets access to download links for the corresponding audio, and the corresponding merchandise is shipped to the consumer. Media distribution system 100 thereafter distributes payment to the artist arising from the transaction, for example from about $12.75 to about $15.75 per $25.00 transaction. It will be appreciated that this payment still exceeds the industry standard rate of $9.99 for a full album download.

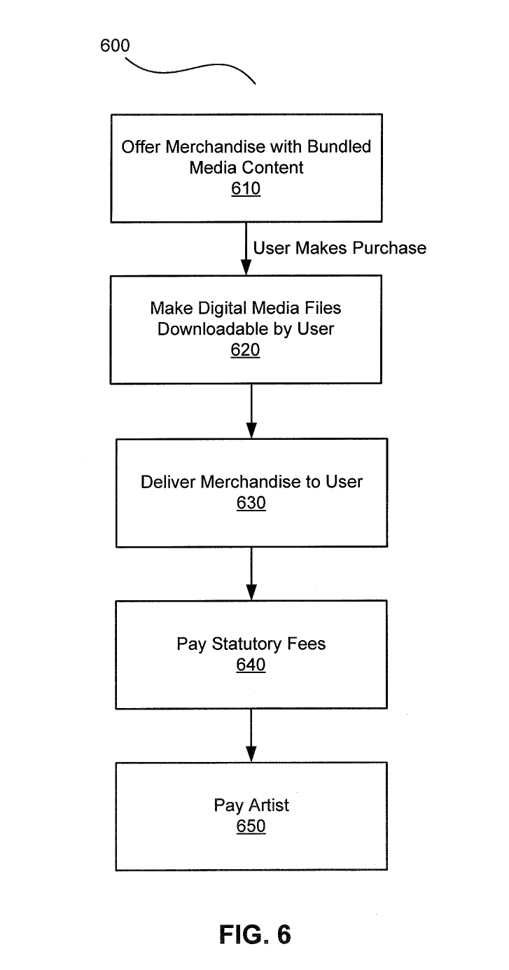

With reference now to FIG. 6, in an exemplary embodiment a method 600 for media distribution comprises offering, via a media distribution system (for example, media distribution system 100), an item of merchandise for sale in connection with bundled media content (step 610). Responsive to a user completing a purchase for the bundled merchandise and media content, media distribution system 100 makes a digital file or files containing the media content available for download by the user (step 620). Media distribution system 100 facilitates delivery of the merchandise to the user (step 630), and the delivery may include (in addition to the merchandise) physical media containing the media content (for example, a compact disc, DVD, and/or the like). Media distribution system 100 makes a statutory payment to the publisher and performance rights group (step 640) and a payment to the artist (step 650).

Exemplary systems and methods may be described herein in terms of functional block components, screen shots, optional selections and various processing steps. It should be appreciated that such functional blocks may be realized by any number of hardware and/or software components configured to perform the specified functions.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., Facebook, YOUTube®, AppleTV®, Pandora®, xBox®, Sony® Playstation®, iPad, iPhone, a uniform resource locator (“URL”), an “ebook,” an “emagazine,” an application or microapplication) or any combination of the foregoing.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure and may be expressed in the following claims.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element of any or all the claims.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection. When language similar to “at least one of A, B, or C” or “at least one of A, B, and C” is used in the claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A method for media distribution, the method comprising:
delivering, via an electronic media distribution system, a streaming media file to a user, wherein the streaming media file is delivered to the user a plurality of times; and
responsive to the streaming media file being delivered to the user a selected number of times, providing, in the electronic media distribution system, a downloadable file for download by the user, wherein the downloadable file contains content corresponding to the streaming media file.

2. The method of claim 1, further comprising, responsive to the delivering the streaming media file to the user:
delivering, via the electronic media delivery system, payment to an artist associated with the streaming media file;
delivering, via the electronic media delivery system, payment to a copyright holder associated with the streaming media file; and
delivering, via the electronic media delivery system, payment to a publisher associated with the streaming media file.

3. The method of claim 2, further comprising:
after the streaming media file is delivered to the user the selected number of times, delivering the streaming media file to the user an additional time without incurring a payment obligation to at least one of an artist, a copyright holder, or a publisher associated with the streaming media file.

4. The method of claim 2, further comprising:
responsive to downloading of the downloadable file by the user, delivering, via the electronic media delivery system, payment to an artist associated with the downloadable file.

5. The method of claim 1, wherein the streaming media file is associated with at least one of a standard payment tier or a premium payment tier, and wherein the selected number of times is selected based on the payment tier.

6. The method of claim 5, wherein the payment tier associated with the streaming media file is selected by the artist corresponding to the streaming media file.

7. The method of claim 5, wherein the premium payment tier artist payment is at least twenty times larger than the standard tier artist payment.

8. The method of claim 1, wherein the streaming media file is delivered to the user without financial payment by the user.

9. The method of claim 1, further comprising delivering, via the electronic media delivery system, payment to an artist associated with the streaming media file, wherein the payment to the artist exceeds the amount the artist would have collected for a conventional purchase of the content of the streaming media file.

10. The method of claim 9, wherein the payment to the artist is sourced, in the electronic media delivery system, from funds acquired via at least one of:
sales an artist makes from selling and promoting content in the electronic media delivery system;
sign-up fees paid by a content owner to host content in the electronic media delivery system;
fees paid by at least one of a content owner or a record label to advertise in the electronic media delivery system;
donations from users of the electronic media delivery system;
fees paid by a third party to sponsor content in the electronic media delivery system; or
fees paid by a third party to advertise in the electronic media delivery system.

11. The method of claim 1, wherein the electronic media delivery system does not require a surrender of ownership, copyright or shares of royalties made from traditional product sales.

12. A system for electronic media distribution, comprising:
a streaming component configured to provide streaming delivery of electronic media to a user;
a payment component configured to receive payments from users for purchases of media; and
a download component configured to provide electronic media in downloadable format to the user,
wherein, responsive to a streaming media file being delivered to the user by the streaming component a selected number of times, the download component provides access to a downloadable file for download by the user, and wherein the downloadable file contains content corresponding to the streaming media file.

13. The system of claim 12, wherein the streaming media file is associated with at least one of a standard payment tier or a premium payment tier, and wherein the selected number of times is selected based on the payment tier.
